(19) United States
(12) Patent Application Publication
(10) Pub. No.: US 2026/0012357 A1
(43) Pub. Date: Jan. 8, 2026

(54) METHOD AND SYSTEM FOR SECURE CONTROL WITH REGARD TO A SMART METER

(71) Applicant: SAGEMCOM ENERGY & TELECOM SAS, Bois-Colombes (FR)

(72) Inventor: Ziv ROTER, Bois-Colombes (FR)

(73) Assignee: SAGEMCOM ENERGY & TELECOM SAS, Bois-Colombes (FR)

(21) Appl. No.: 19/248,073

(22) Filed: Jun. 24, 2025

(30) Foreign Application Priority Data
Jul. 8, 2024 (FR) 2407438

(51) Int. Cl. H04L 9/32; G01R 22/06

(52) U.S. Cl. CPC H04L 9/3247; G01R 22/063; H04L 9/321

(57) ABSTRACT

A management device in an automated management system remotely managing the smart meters transmits a secure command while: implementing a protection that generates a signature on a set of data formed by attributes to be applied at the input of an operation to be performed and metadata associated with the command, and transmitting, to the smart meter in question, the command with the descriptor of the operation to be performed, the input attributes of the operation to be performed, the metadata associated with the command and the first signature generated. The management device includes in the metadata a copy of the descriptor of the operation to be performed, so that the signature also applies to the copy of the descriptor of the operation to be performed in order to make it possible, on reception, to verify that the command has not been altered.

### TECHNICAL FIELD

At least one embodiment relates to a method and system for secure control with regard to a smart meter. The system in question is adapted to enable a managing device to ensure that commands transmitted to a smart meter are not manipulated on the way and that operations performed by the smart meter actually correspond to the commands transmitted.

### PRIOR ART

Smart meters are known, of the electricity meter type (electrical-consumption meters) or fluid meters (fluid-consumption meters), which comprise communication interfaces enabling an automated management system to make a remote collection of consumption data. For example, smart electricity meters comprise a communication interface of the powerline communication (PLC) type. Exchanges can thus be made between the smart meters and an information system IS managing them in a centralised manner. This enables the information system IS to send commands to the smart meters to make them perform various operations, such as operations of transmitting meter readings, operations of changing operational parameters (for example a change to the energy-consumption lower threshold or a change of calendar profile), software-update operations, events-diary deletion operations, functionality activation/deactivation operations (for example power cut), etc.

Some of these operations are considered to be “critical” since they may have serious non- reversible consequences if they are wrongly triggered. However, data alterations may occur during the routing of commands from the information system IS to the smart meters, either through interference or by malevolent action.

So as to take precautions against an alteration to command attributes, the COSEM (“Companion Specification for Energy Metering”) specifications require certain commands to be accepted only if they use a COSEM data-protection object (object called “DATA PROTECTION”, such as for example set out in the work “Bluebook DLMS” V16 Part 2 § 4.4.9), which affix a signature (asymmetric encryption) to the attributes, and to associated metadata (transaction number, date of command, cryptographic identity of the signatory, cryptographic identity of the recipient). For the record, the COSEM specifications define a model in the form of objects to formalise instructions (commands) and more generally data exchanges. The objects are combinable so as to make it possible to perform an entire panel of operations, whether they be simple, such as register readings, or more complex, such as load-management operations. The COSEM specifications are sufficiently generic to make it possible to model various use cases beyond energy management (water-distribution management, for example).

Protecting attributes, and associated metadata, in particular allowed by the COSEM specifications by means of the object of the “DATA PROTECTION” type, is an important tool for making transmissions of commands secure in an automated (remote) smart-meter management system. This prevents operations with altered attributes being performed inadvertently.

However, making the transmission of commands secure by protecting attributes is an imperfect solution. This is because various commands may use identical or compatible attributes. And the protection of attributes offered by the object of the “DATA PROTECTION” type has no effect against an alteration of the command itself (“invoked method” is spoken of in the COSEM specification terminology), typically an alteration of a command identifier.

For example, let us consider that the “remote_connect( )” method of an object of the “DISCONNECTOR” class is invoked using an object of the “DATA PROTECTION” type to order a power-supply activation. Only the parameter (attribute) of this method (an integer equal to “0”) is protected by the object of the “DATA PROTECTION” type. If an alteration on the way changes the identifier of the method invoked into “remote_disconnect( )”, an operation that is the complete reverse of the power-supply deactivation is performed.

It is therefore desirable to provide a solution that makes it possible to reinforce the protection of commands transmitted in a system for remote automated management from a management device to smart meters, so as to ensure that the smart meter performs the operation that was actually required.

### DISCLOSURE OF THE INVENTION

For this purpose, a method is proposed for transmitting a secure command in a system for automated management of smart meters, the command comprising a descriptor of the operation to be performed by a said smart meter and input attributes of the operation to be performed and metadata associated with the command, the method comprising the following steps performed by a management device of the automated management system remotely managing the smart meters:
implementing a protection that generates a first signature on a set of data formed by the input attributes of the operation to be performed and the metadata associated with the command;
transmitting, to the smart meter in question, the command with the descriptor of the operation to be performed, the input attributes of the operation to be performed, the metadata associated with the command and the first signature generated;
including, in the metadata associated with the command, a copy of the descriptor of the operation to be performed, so that the first signature also applies to the copy of the descriptor of the operation to be performed in order to make it possible, on reception, to verify that the command has not been altered during transmission.

Thus the protection of the commands transmitted in a system of automated remote management from a management device to smart meters is reinforced by the clever copying of the descriptor of the operation to be performed within the metadata that benefit from protection by signature. It is thus possible to verify on reception that the operation to be performed is indeed the one initially required (when, on reception, the copy is compliant and the signature is compliant).

In a particular embodiment, the descriptor of the operation to be performed and the copy thereof contain an identifier of the operation to be performed.

Thus, although a simple descriptor of the operation to be performed could easily undergo alteration that could lead to performing an operation other than the one initially required, the clever copying of the descriptor of the operation to be performed within metadata that benefit from protection by signature is sufficient to make it possible to ensure that the operation to be performed is indeed the one initially required.

In a particular embodiment, the automated management of smart meters is implemented in accordance with an object-oriented modelling, the descriptor of the operation to be performed and the copy thereof contain a class identifier of at least one object manipulated to perform the operation in question.

Thus, although a simple identifier of classes of objects manipulated to perform the required operation could easily undergo alteration that could lead to performing an operation other than the one initially required, the clever copying of the descriptor of the operation to be performed within metadata that benefit from protection by signature is sufficient to make it possible to ensure that the operation to be performed is indeed the one initially required.

In a particular embodiment, the object-oriented modelling is of the COSEM type and the protection that generates the first signature is obtained by an object of the DATA PROTECTION type.

Thus the clever copying of the descriptor of the operation to be performed makes it possible to ensure the protection sought whereas the COSEM object of the DATA PROTECTION type is not designed to protect the identification of the operation to be performed but only the attributes thereof and associated metadata.

In a particular embodiment, the method furthermore comprises the following steps, on reception of the command, of verifying the command, performed by the smart meter in question to which said command was transmitted:
recovering, in the command received, the descriptor of the operation to be performed;
recovering, in the command received, the input attributes to be applied as an input of the operation to be performed, as well as the metadata associated with the command;
verifying that the copy of the descriptor of the operation to be performed in the metadata recovered conforms to the descriptor of the operation to be performed recovered and, when such is not the case, rejecting the command;
recovering, in the command received, and verifying that the first signature in the command conforms to the input attributes to be applied as an input to the operation to be performed and to said metadata, including the copy of the descriptor of the operation to be performed, which were recovered in the command, and, when such is not the case, rejecting the command, and otherwise accepting the command.

Thus the smart meter in question to which said command was transmitted is assured that the command has not been altered during transmission.

In a particular embodiment, the verification of the command is also implemented by a data concentrator acting as a relay between the management device and the smart meter in question in the automated management system.

Thus it is verified that the command has not been altered between the management device and the data concentrator and, if such has been the case, this verification avoids unnecessarily acting on the smart meter (and network resources between the data concentrator and the smart meter in question).

In a particular embodiment, the method furthermore comprises the following steps, after the operation demanded has been performed, performed by the smart meter in question to provide a response to the command:
recovering output attributes, and metadata associated with the response, to be supplied to the management device as results of the implementation of the command;
including, in the metadata associated with the response, the descriptor of the operation to be performed that had been supplied in the command;
implementing a protection that generates a second signature on a set of data formed by the output attributes and the metadata associated with the response;
transmitting, to the management device, a response with the output attributes, said metadata including the descriptor of the operation to be performed that had been supplied in the command, and the second signature generated.

Thus the protection is also reinforced for the response made to the command.

In a particular embodiment, the method furthermore comprises the following steps, on reception of the response, of verifying the response, performed by the management device:
recovering, in the response received, the output attributes that result from the operation performed, as well as the metadata associated with the response;
recovering in memory the descriptor of the operation to be performed that had initially been transmitted in the command to which the response is supposed to correspond;
verifying that the metadata recovered in the response correspond to the descriptor of the operation to be performed, and, when such is not the case, rejecting the response;
recovering, in the response received, and verifying that the second signature conforms to the output attributes and the metadata associated with the response, which were recovered in the response, and, when such is not the case, rejecting the response, and otherwise accepting the response.

Thus the management device is assured that the response to its command has not been altered during transmission and is particularly assured that the response in question does indeed correspond to its initial command.

In a particular embodiment, the verification of the response is also implemented by a data concentrator acting as a relay between the management device and the smart meter in question in the automated management system.

Thus it is verified that the command has not been altered between the smart meter and the data concentrator and, if such has been the case, this verification avoids unnecessarily acting on the management device (and network resources between the data concentrator and the management device).

A management device is also proposed here comprising electronic circuitry configured to implement a transmission of a secure command in a system for automated management of smart meters where the management device is configured to remotely manage the smart meters, the command comprising a descriptor of the operation to be performed by a said smart meter and input attributes of the operation to be performed and metadata associated with the command, the electronic circuitry being configured to perform the following steps:
implementing a protection that generates a first signature on a set of data formed by the input attributes of the operation to be performed and the metadata associated with the command;
transmitting, to the smart meter in question, the command with the descriptor of the operation to be performed, the input attributes of the operation to be performed, the metadata associated with the command and the first signature generated;
including, in the metadata associated with the command, a copy of the descriptor of the operation to be performed, so that the first signature also applies to the copy of the descriptor of the operation to be performed in order to make it possible, on reception, to verify that the command has not been altered during transmission.

A smart meter is also proposed here, configured to process a command received from a management device in an automated management system where the management device is configured to remotely manage the smart meter, the command comprising a descriptor of the operation to be performed by said smart meter and input attributes of the operation to be performed and metadata associated with the command. The smart meter comprises electronic circuitry configured to perform the following steps, on reception of the command, for verifying the command:
recovering, in the command received, the descriptor of the operation to be performed;
recovering, in the command received, the input attributes to be applied as an input of the operation to be performed, as well as the metadata associated with the command;
verifying that the copy of the descriptor of the operation to be performed in the metadata recovered conforms to the descriptor of the operation to be performed recovered and, when such is not the case, rejecting the command;
recovering, in the command received, and verifying that the first signature in the command conforms to the input attributes to be applied as an input to the operation to be performed and to said metadata, including the copy of the descriptor of the operation to be performed, which were recovered in the command, and, when such is not the case, rejecting the command, and otherwise accepting the command.

A system for automated management of smart meters is also proposed here, comprising a management device as disclosed above and smart meters as disclosed above.

A method implemented by a smart meter in order to process a command received from a management device in an automated management system where the management device is configured to remotely manage the smart meter is also proposed here, the command comprising a descriptor of an operation to be performed by said smart meter and input attributes of the operation to be performed and metadata associated with the command. The method comprises the following steps, on reception of the command, for verifying the command:
recovering, in the command received, the descriptor of the operation to be performed;
recovering, in the command received, the input attributes to be applied as an input of the operation to be performed, as well as the metadata associated with the command;
verifying that the copy of the descriptor of the operation to be performed in the metadata recovered conforms to the descriptor of the operation to be performed recovered and, when such is not the case, rejecting the command;
recovering, in the command received, and verifying that the first signature in the command conforms to the input attributes to be applied as an input to the operation to be performed and to said metadata, including the copy of the descriptor of the operation to be performed, which were recovered in the command, and, when such is not the case, rejecting the command, and otherwise accepting the command.

A computer program product is also proposed here, comprising instructions causing the implementation by a processor of one or other of the methods disclosed above, in any one of the embodiments thereof, when the instructions are executed by the processor.

An information-storage medium is also proposed here, storing instructions causing the implementation by a processor of one or other of the methods disclosed above, in any one of the embodiments thereof, when the instructions are read from the information-storage medium and executed by the processor.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically an automated management system for smart meters;

FIG. 2 shows a logic representation of interactions between a management device and a smart meter of the automated management system;

FIG. 3 illustrates schematically an example of hardware architecture, which is adapted to implement a device of the automated management system;

FIG. 4 illustrates schematically a principle of generating and affixing a signature;

FIG. 5 illustrates schematically a flow diagram of a method for formatting and transmitting a command initiated by the management device and intended for the smart meter;

FIG. 6 illustrates schematically a flow diagram of a verification method for accepting or rejecting a command received;

FIG. 7 illustrates schematically a flow diagram of a method for formatting and transmitting a response to a command that was initiated by the management device and intended for the smart meter, in a particular embodiment; and

FIG. 8 illustrates schematically a flow diagram of a verification method for accepting or rejecting the response formatted in accordance with FIG. 7.

### DETAILED DISCLOSURE OF EMBODIMENTS

FIG. 1 illustrates schematically an automated management system 100 wherein the present invention can be implemented. The automated management system 100 is configured to implement a remote management of smart meters 151, 152, 153 (e.g. electricity, water, gas, heat, other fluids).

The remote management of smart meters 151, 152, 153 is provided by a management device 111 of an information system IS 110. In many solutions of such automated management systems, the management device 111 is a meter data management system MDMS.

The information system 110 typically furthermore includes a key management system KMS that is configured to store encryption keys necessary for the smart meters that depend on the information system IS 110 in question. The key management system KMS is configured to supply to the management device 111, such as the meter data management system MDMS, the keys necessary for the encryptions/decryptions that have to be implemented with regard to the smart meters 151, 152, 153. In a variant, the management device 111 has, by prior configuration, keys necessary for the encryptions/decryptions that have to be implemented with regard to the smart meters 151, 152, 153.

The management device 111 manages the smart meters 151, 52, 153 through a network infrastructure managed by a data concentrator DC 120. The data concentrator DC 120 thus manages a first communication network NET1 101 via which the communications with the smart meters 151, 152, 153 are established. The data concentrator DC 120 thus serves as a relay between the smart meters 151, 152, 153 and the information system IS 110 (including the management device 111).

As illustrated schematically in FIG. 1, the data concentrator DC 120 is external to the information system IS 110 and communicates with the information system IS (including the management device 111) by means of a second communication network NET2 102.

Typically, the information system IS 110 interacts with several data concentrators DC 120 through the second communication network NET2 102, each of the data concentrators DC 120 managing the communications with its own group of smart meters.

For example, the first communication network NET1 101 is a network of the powerline communications PLC type, such as is compliant with the G3-PLC or PRIME specifications. According to another example, the first communication network NET1 101 is a wireless network of the LPWAN (low-power wide area network) type such as is found in the Internet of Things IoT).

For example, the second communication network NET2 102 is a wireless communication network of the 5G (5th generation) type. According to other examples, the communication network NET2 102 is a wireless network of the GPRS (“General Packet Radio Service”), UMTS (“Universal Mobile Telecommunication System”) or LTE (“Long-Term Evolution”) type.

Other technologies can be used to implement the first communication network NET1 101 and the second communication network NET2 102.

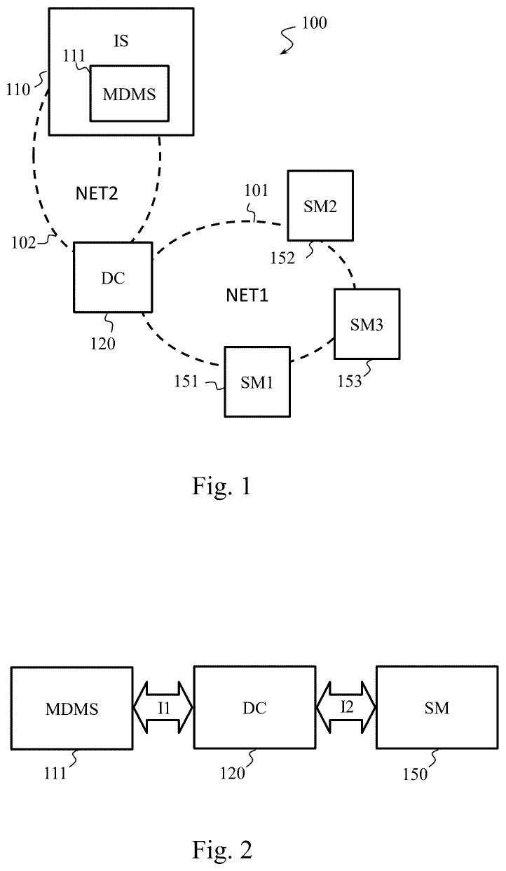

A logic representation of the interactions between the management device 111, such as the MDMS system, and a said smart meter 150 by means of the data concentrator DC 120 is shown on FIG. 2. These three elements may be different suppliers (manufacturers) and are typically located at different places.

An interface I1 is defined for the exchanges between the management device 111 and the data concentrator DC 120, and an interface I2 is defined for the data concentrator DC 120 and the smart meter 150.

In a DLMS (“Device Language Message Specifications”) implementation, the management device 111 has a role of third (or third-party) device with regard to the pair consisting of DLMS client and DLMS server formed by respectively by the data concentrator DC 120 and the smart meter 150.

The interface I1 then enables the third party to give instructions to the DLMS client and to recover the results therefrom. These instructions are typically in a proprietary format (for example based on XML (“extensible Markup Language”), JSON (“JavaScript Object Notation”) or other) in a secure application transport protocol of the HTTPS (“Hypertext Transfer Protocol Secure”) type but manipulates commands and business data to the COSEM/A-XDR format (where A-XDR is an encoding format, referenced by the DLMS/COSEM specifications, and defined in IEC 61334-6).

The interface I2 enables the DLMS client to connect to the DLMS meter/server, to send instructions and to recover the results using the DLMS protocol to manage the commands and the business data to the COSEM/A-XDR format.

The DLMS client provides the transport format conversions between the first NET1 101 and second NET2 102 communication networks. In particular, a symmetric-encryption protection layer can be added for the transmissions on the first communication network NET1 101.

To ensure the integrity of the commands from the management device 111 to the smart meter 150, a signature is generated and affixed as detailed below in relation to FIG. 4, for example by means of a COSEM object of the “DATA PROTECTION” type.

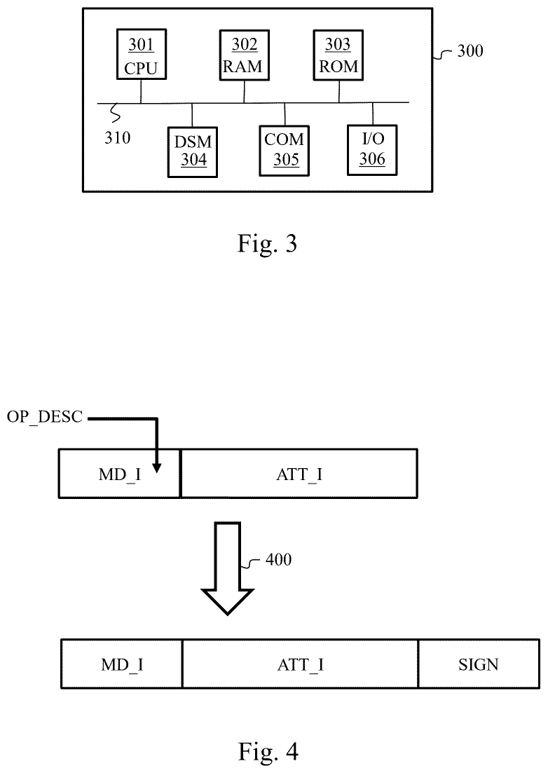

FIG. 3 illustrates schematically an example of hardware architecture 300, which is adapted to implement any device controller of the automated management system 100. The example of hardware architecture is thus adapted to implement a controller of the information system IS 110, or of any component of the information system IS 110. The example of hardware architecture is also adapted to implement a controller of the data concentrator DC 120. The example of hardware architecture is also adapted to implement a controller of a smart meter 150, 151, 152, 153.

The hardware architecture 300 therefore comprises, connected by a communication bus 310: a processor or CPU (“central processing unit”) 301; a random access memory (RAM) 302; a read only memory (ROM) 303, or EEPROM (“electrically erasable programmable ROM”), or a flash memory; a data storage medium DSM 304, such as a hard disk drive HDD, or a storage medium reader, such as an SD (Secure Digital) card reader; and at least one communication interface COM 305. Depending on the device in question, the hardware architecture 300 may furthermore comprise inputs/outputs I/O 306, for example to make consumption measurements (smart meters).

The processor 301 is capable of executing instructions loaded in the RAM 302 from the ROM 303, from an external memory (not shown), from a storage medium, such as an SD card, or from a communication network. When the hardware architecture 300 is powered up, the processor 301 is capable of reading instructions from the RAM 302 and executing them. These instructions form a computer program causing the implementation, by the processor 301, of the steps and algorithms described here in relation to the device concerned.

All or some of the steps and algorithms described here can thus be implemented in software form by executing a set of instructions by a programmable machine, such as a DSP (“digital signal processor”) or a microcontroller, or be implemented in hardware form by a machine or a component (chip) or a set of components (chipset), such as an FPGA (field-programmable gate array) or an ASIC (application-specific integrated circuit). In general terms, each device of the automated management system 100 comprises electronic circuitry arranged and configured to implement the steps and algorithms described here in relation to the device in question.

FIG. 4 illustrates schematically a principle of command protection by generating and affixing a signature.

As proposed by the COSEM specifications, a signature is affixed by asymmetric encryption by means of a private key to a set of data formed by input attributes ATT_I to be taken as an input of the operation to be performed, as well as metadata MD_I associated with the command.

The commands protected in accordance with the protection principle of FIG. 4 are commands that comprise input attributes ATT_I (e.g. commands of the “SCT” type for updating data (register, table, parameter etc.) of the smart meter or of the “ACTION” type for causing an action to be performed by the smart meter), and therefore for which a mechanism of protection by signature can be applied conjointly with metadata associated with the command.

In the COSEM specifications, these metadata are a transaction number (“transaction-id” metadata), cryptographic identity of the signature (“originator-system-title” metadata), time of the command (“date-time” metadata), cryptographic identity of the recipient (“recipient-system-title” metadata). Other metadata can be added (“other-information” metadata existing or in a metadata field “object-list” added for this purpose). The metadata are therefore data that are not necessary for performing the operation itself, since the data necessary for performing the operation itself are located elsewhere in the command, but which provide supplementary information.

The operation to be performed is presented in a descriptor OP_DESC (e.g. COSEM object(s) that is not in the coverage area of the signature in the command. It is proposed here to furthermore include in the metadata MD_I (more particularly in the existing “other-information” metadata or via the addition of a new metadata field “object-list”) a copy of this descriptor of the operation to be performed OP_DESC.

In a particular embodiment, the descriptor of the operation to be performed OP_DESC and the copy thereof contain an identifier of the operation to be performed (for example a method number).

In a particular embodiment where the automated management of the smart meters is implemented in accordance with an object-oriented modelling (as in the COSEM specifications), the descriptor of the operation to be performed OP_DESC and the copy thereof contain a class identifier of at least one object manipulated to perform the operation in question.

For example, if the operation to be performed is an activation of an electrical supply for a smart electricity meter, a suitable descriptor of the operation to be performed OP_DESC (and the corresponding copy thereof) contains the OBIS (“Object Identification System”) code and a method number that correspond, in a predefined manner, to the method “Disconnector.remote_connect( )” of the DLMS/COSEM specifications.

In a particular embodiment where the automated management of the smart meters is implemented in accordance with an object-oriented modelling (as in the COSEM specifications), the descriptor of the operation to be performed OP_DESC is a list of COSEM objects representing the operation to be performed.

Thus, after a signature SIGN is generated 400 from input attributes ATT_I at the input of the operation to be performed and metadata MD_I (including therefore the copy of the descriptor of the operation to be performed OP_DESC), the signature SIGN is affixed as an accompaniment to the input attributes ATT_I as an input to the operation to be performed and metadata MD_I. It is then possible to verify on reception, by means of the public key corresponding to the private key used for generating the signature, that not only have the input attributes not been altered but also, above and beyond the metadata other than those of the copy describing the operation to be performed OP_DESC, that the operation demanded is indeed the one initially requested by the management device 111.

In particular, in the context of the DLMS/COSEM specifications, the command protection principle presented above is advantageously applied to the following operations (with the corresponding class numbers in the specifications):
activation of power supply (opening of breaker) via an object of class 70 “DISCONNECT CONTROL”;
configuration of an overconsumption-detection lower threshold via an object of class 71 “LIMITER”;
downloading and activation of application software via an object of class 18 “IMAGE TRANSFER”;
activation of a price calendar via an object of class 20 “ACTIVITY CALENDAR”;
definitive deletion of events diaries (potentially tracing security events) via an object of class 7 “PROFILE GENERIC ”.

As described below, this same principle is applicable for the response transmitted by the electricity meter 150 in question with output attributes ATT_O and metadata MD_O associated with the response.

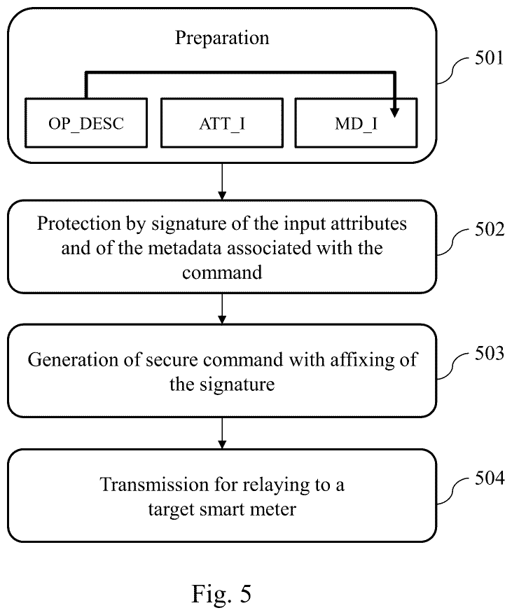

FIG. 5 illustrates schematically a flow diagram of a method for formatting and transmitting a command initiated by the management device 111 and intended for a said smart meter 150.

In a step 501, the management device 111 prepares the command. The command corresponds to the operation to be performed by the smart meter in question 150 (target smart meter). The management device 111 generates a descriptor of the operation to be performed OP_DESC as mentioned above in relation to FIG. 4.

The management device 111 prepares the input attributes ATT_I to be applied at the input of the operation to be performed. For example, the operation to be performed is an updating of a price calendar and the input attributes ATT_I include a new price calendar to be applied.

The management device 111 prepares the metadata MD_I associated with the command. The management device 111 includes, in the metadata MD_I, a copy of the descriptor of the operation to be performed OP_DESC.

In a step 502, the management device 111 protects the input attributes ATT_I and the metadata MD_I (including therefore the copy of the descriptor of the operation to be performed OP_DESC) by generating the signature as already described (asymmetric encryption with the private key of the management device 111). In the context of the COSEM specifications, this operation is performed by means of an object of the “DATA PROTECTION” type.

In a step 503, the management device 111 affixes the generated signal to the command. The command therefore repeats the descriptor of the operation to be performed, the attributes ATT_I, the metadata MD_I and the signature generated, in order to make it possible, on reception, to verify that the command has not been altered during transmission.

In a step 504, the management device 111 transmits the command thus made secure to the data concentrator DC 120 for relaying as far as the smart meter 150 in question (target smart meter).

Preferentially, the management device 111 keeps in memory the descriptor of the operation to be performed OP_DESC as sent, until a response from the smart meter 150 in question reaches it (or an expiry time greater than a predefined duration threshold is reached).

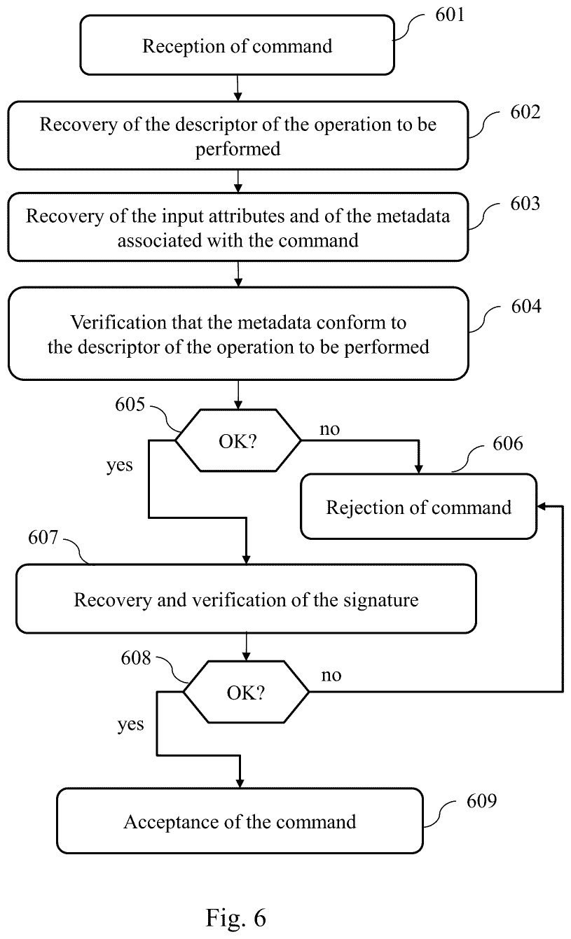

FIG. 6 illustrates schematically a flow diagram of a verification method for accepting or rejecting a command received. The command was generated and transmitted in accordance with the method described above in relation to FIG. 5 to a said smart meter 150 (target smart meter).

In a step 601, the smart meter 150 in question receives the command.

In a step 602, the smart meter 150 recovers, in the command received, (what is supposed to be) the descriptor of the operation to be performed OP_DESC (apart from the metadata part MD_I of the command).

In a step 603, the smart meter 150 recovers, in the command received, (what is supposed to be) the input attributes ATT_I to be applied at the input of the operation to be performed, as well as (what is supposed to be) the metadata MD_I associated with the command.

In a step 604, the smart meter 150 verifies that the metadata MD_I recovered at the step 603 (i.e. those that are supposed to include the copy of the descriptor of the operation to be performed OP_DESC) conform to the descriptor of the operation to be performed OP_DESC recovered at the step 602. In other words, the smart meter 150 verifies that the copy of the operation to be performed OP_DESC in the metadata MD_I recovered at the step 603 is identical to the descriptor of the operation to be performed OP_DESC recovered at the step 602. This makes it possible to verify that the descriptor of the operation to be performed OP_DESC has not been altered (solely) at one of the two places where it is inscribed or copied in the command.

Then, in a step 605, the smart meter 150 tests whether the verification of the step 604 is positive. When the metadata MD_I recovered at the step 603 do not conform to the descriptor of the operation to be performed OP_DESC recovered at the step 602, the smart meter 150 rejects the command in a step 606, which ends the method. Otherwise, a step 607 is performed.

In a step 607, the smart meter 150 recovers, in the command received, and verifies, by means of the public key of the management device 111, that the signature conforms to the input attribute ATT_I to be applied at the input of the operation to be performed and to the metadata MD_I associated with the command, which were recovered at the step 602.

Then, in a step 608, the smart meter 150 tests whether the verification of the step 607 is positive. When the signature does not conform to the input attributes ATT_I to be applied at the input of the operation to be performed and the metadata MD_I associated with the command, the step 606 is performed. Otherwise, a step 609 is performed.

In the step 609, the smart meter 150 accepts the command, noting that is has not been altered during routing thereof from the management device 111.

For example, let us consider that the “remote_connect( )” method of a COSEM object of the “DISCONNECTOR” class is invoked using an object of the “DATA PROTECTION” type to order a power-supply activation (ACTION) with a said smart meter 150. If an alteration on the way changes the identifier of the method invoked into remote_disconnect( ) this alteration is detected on reception and the performance of an operation that is different (here the opposite) to what was initially required is avoided.

According to another example, let us consider the case of the configuration of an overconsumption-detection lower threshold by means of an object of the “LIMITER” type (class 71). If an alteration on the way changes the command “SET threshold_normal” into “SET threshold_emergency”, this alternation is detected on reception and the performance of an operation (here configuration of the threshold for different operational situations) that is different from what was initially required is avoided.

Other checks can be made by the smart meter 150, in particular concerning the metadata MD_I. For example, the smart meter 150 can verify that the date of the command (“date-time” metadata) is not too old compared with an elapsed time limit threshold. Thus the smart meter 150 can verify that the cryptographic identity of the signatory (“originator-system-title” metadata and/or cryptographic identity of the recipient (“recipient-system-title” metadata) conform to expected identities.

In one particular embodiment, the method of FIG. 6 is also implemented by the data concentrator DC 120, since the data concentrator DC 120 has knowledge of the public key corresponding to the private key used by the management device 111 for generating the signature. Thus, if the data concentrator DC 120 is a trusted device, this makes it possible to verify, before relaying the command to the smart meter 150 concerned, that the command has not been altered on the interface I1 and to reject it without forwarding it to the smart meter 150 where applicable.

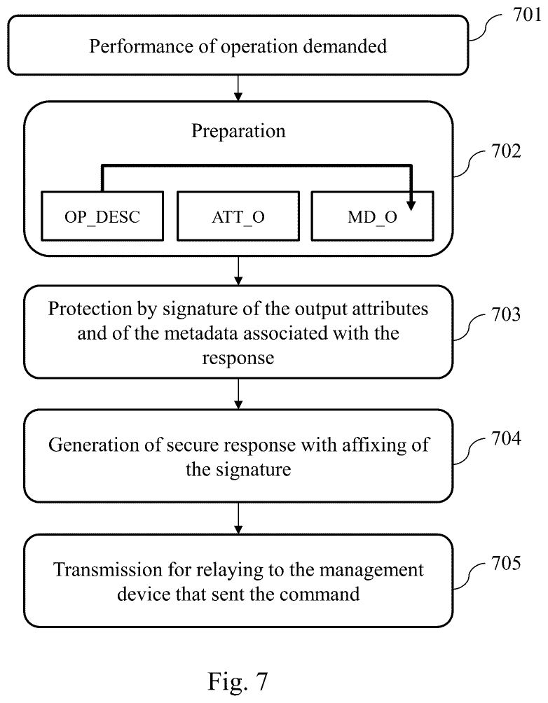

FIG. 7 illustrates schematically a flow diagram of a method for formatting and transmitting a response to a command that was initiated by the management device 111 and intended for the smart meter 150, in a particular embodiment.

In a step 701, the smart meter 150 in question performs the operation demanded, after having implemented the verification method of FIG. 6.

In a step 702, the smart meter 150 prepares the response to the command. The smart meter 150 repeats the descriptor of the operation to be performed OP_DESC that had been supplied in the command. The smart meter 150 recovers output attributes ATT_O, and associated metadata MD_O, to be supplied to the management device 111 as command-execution results. The output attributes ATT_O typically include a success code or an error code with regard to the command-execution results. The output attributes ATT_O may include other information, such as for example a register value resulting from the performance of the operation demanded.

The smart meter 150 includes, in the metadata MD_O, the descriptor of the operation to be performed OP_DESC that had been supplied in the command. This enables the management device 111 to have confirmation that the verification of the command has indeed been implemented.

Preferentially, the metadata MD_O of the response include a transaction number (“transaction-id” metadata) that repeats a transaction number that had been included in the metadata MD_I of the corresponding command, in order to make it possible to determine to which command the response corresponds.

In a step 703, the smart meter 150 protects the output attributes ATT_O and the metadata MD_O (including therefore the copy of the descriptor of the operation to be performed OP_DESC) by generating the signature as already described (asymmetric encryption with the private key of the smart meter 150).

In a step 704, the smart meter 150 affixes, to the response, the signature generated.

In a step 705, the smart meter 150 transmits the response thus protected to the data concentrator DC 120 for relaying to the management device 111.

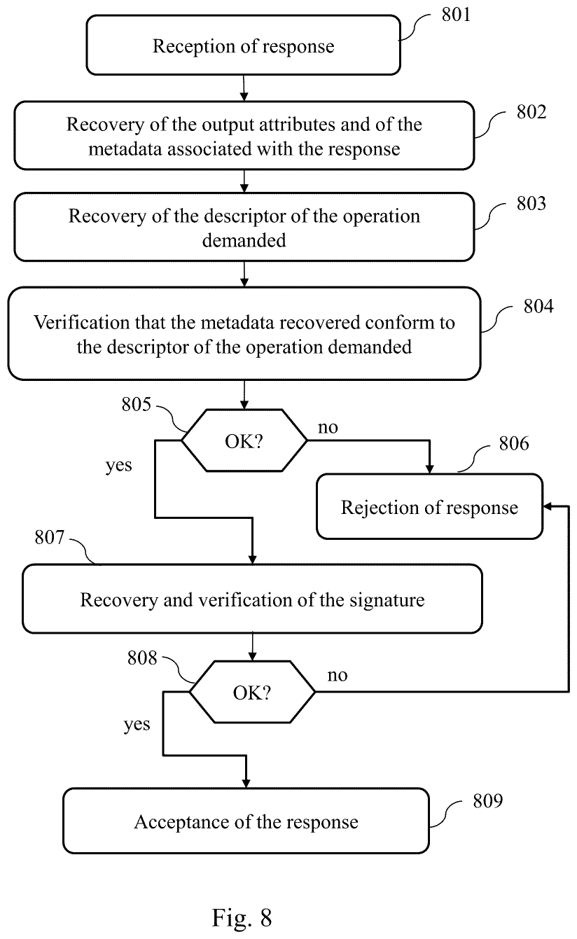

FIG. 8 illustrates schematically a flow diagram of a verification method for accepting or rejecting a response received. The response was generated and transmitted in accordance with the method described above in relation to FIG. 7.

In a step 801, the management device 111 receives the response in question.

In a step 802, the management device 111 recovers, in the response received, (what is supposed to be) the output attributes ATT_O that result from the operation performed, as well as (what is supposed to be) the metadata MD_O associated with the response.

In a step 803, the management device 111 recovers, in memory, the descriptor of the operation to be performed OP_DESC that had initially been transmitted in the command to which the response is supposed to correspond. Preferentially, the metadata MD_O of the response include a transaction number that is equal to a transaction number that had been included in the metadata MD_I of the corresponding command, which makes it possible to easily find which is the descriptor OP_DESC in question.

In a step 804, the management device 111 verifies that the metadata MD_O recovered at the step 802 correspond to the descriptor of the operation to be performed OP_DESC recovered at the step 803.

Then, in a step 805, the management 111 tests whether the verification of the step 804 is positive. When the metadata MD_O recovered at the step 802 do not conform to the descriptor of the operation to be performed OP_DESC recovered at the step 803, the management device 111 rejects the response in a step 806, which ends the method. Otherwise, a step 807 is performed.

In the step 807, the management device 111 recovers, in the response received, and verifies, by means of the public key of the smart meter 150 that transmitted the response, that the signature conforms to the output attributes ATT_O and the metadata MD_O, which were recovered at the step 803.

Then, in a step 808, the management device 111 tests whether the verification of the step 807 is positive. When the signature conforms to the output attributes ATT_O and the metadata MD_O, a step 809 is performed. Otherwise, the step 806 is performed.

In the step 809, the management device 111 accepts the response, noting that is has not been altered during routing thereof from the smart meter 150 that sent it. The output attributes ATT_O can then be used by the management device 111 since the operation performed by the smart meter 150 corresponds to the command initiated by the management device 111.

Other checks can be made by the smart meter 111, in particular concerning the metadata MD_O. For example, the management device 111 can verify that the date of the response (“date-time” metadata) is not too old compared with an elapsed time limit threshold. Thus the smart meter 150 can verify that the cryptographic identity of the signatory (“originator-system-title” metadata and/or cryptographic identity of the recipient (“recipient-system-title” metadata) conform to expected identities.

In one particular embodiment, the method of FIG. 8 is also implemented by the data concentrator DC 120, since the data concentrator DC 120 has knowledge of the public key corresponding to the private key used by the smart meter 150 in question for generating the signature. Thus, if the data concentrator DC 120 is a trusted device, this makes it possible to verify, before relaying the response to the management device 111, that the response has not been altered on the interface 12 and to reject it without forwarding it to the management device 111 where applicable.

1. A method for transmitting a secure command in a system for automated management of smart meters, the command comprising a descriptor of an operation to be performed by a said smart meter and input attributes of the operation to be performed and metadata (MD_I) associated with the command, the method comprising the following steps performed by a management device of the automated management system remotely managing the smart meters:
implementing a protection that generates a first signature on a set of data formed by the input attributes of the operation to be performed and the metadata associated with the command;
including, in the metadata associated with the command, a copy of the descriptor of the operation to be performed, so that the first signature also applies to the copy of the descriptor of the operation to be performed in order to make it possible, on reception, to verify that the command has not been altered during transmission; and
transmitting, to the smart meter in question, the command with the descriptor of the operation to be performed, the input attributes of the operation to be performed, the metadata associated with the command and the first signature generated.

2. The method according to claim 1, wherein the descriptor of the operation to be performed and the copy thereof contain an identifier of the operation to be performed.

3. The method according to claim 1, wherein the automated management of smart meters is implemented in accordance with an object-oriented modelling, the descriptor of the operation to be performed and the copy thereof contain a class identifier of at least one object manipulated to perform the operation in question.

4. The method according to claim 3, wherein the object-oriented modelling is of the COSEM type and the protection that generates the first signature is obtained by an object of the DATA PROTECTION type.

5. The method according to claim 1, furthermore comprising the following steps, on reception of the command, of verifying the command, performed by the smart meter in question to which said command was transmitted:
recovering, in the command received, the descriptor of the operation to be performed;
recovering, in the command received, the input attributes to be applied as an input of the operation to be performed, as well as the metadata associated with the command;
verifying that the copy of the descriptor of the operation to be performed in the metadata recovered conforms to the descriptor (OP_DESC) of the operation to be performed recovered and, when such is not the case, rejecting the command;
recovering, in the command received, and verifying that the first signature in the command conforms to the input attributes to be applied as an input to the operation to be performed and to said metadata, including the copy of the descriptor of the operation to be performed, which were recovered in the command, and, when such is not the case, rejecting the command, and otherwise accepting the command.

6. The method according to claim 5, wherein the verification of the command is also implemented by a data concentrator acting as a relay between the management device and the smart meter in question in the automated management system.

7. The method according to claim 1, furthermore comprising the following steps, after the operation demanded has been performed, performed by the smart meter in question to provide a response to the command:
recovering output attributes, and metadata associated with the response, to be supplied to the management device as results of the implementation of the command;
including, in the metadata associated with the response, the descriptor of the operation to be performed that had been supplied in the command;
implementing a protection that generates a second signature on a set of data formed by the output attributes and the metadata associated with the response;
transmitting, to the management device, a response including the output attributes, said metadata including the descriptor of the operation to be performed that had been supplied in the command, and the second signature generated.

8. The method according to claim 7, furthermore comprising the following steps, on reception of the response, of verifying the response, performed by the management device:
recovering (802), in the response received, the output attributes that result from the operation performed, as well as the metadata associated with the response;
recovering in memory the descriptor of the operation to be performed that had initially been transmitted in the command to which the response is supposed to correspond;
verifying that the metadata recovered in the response correspond to the descriptor of the operation to be performed, and, when such is not the case, rejecting the response;
recovering, in the response received, and verifying that the second signature conforms to the output attributes and the metadata associated with the response, which were recovered in the response, and, when such is not the case, rejecting the response, and otherwise accepting the response.

9. The method according to claim 8, wherein the verification of the response is also implemented by a data concentrator acting as a relay between the management device and the smart meter in question in the automated management system.

10. A management device comprising electronic circuitry configured to implement a transmission of a secure command in a system for automated management of smart meters where the management device is configured to remotely manage the smart meters, the command comprising a descriptor of the operation to be performed by a said smart meter and input attributes of the operation to be performed and metadata associated with the command, the electronic circuitry being configured to perform the following steps:
implementing a protection that generates a first signature on a set of data formed by the input attributes of the operation to be performed and the metadata associated with the command;
including, in the metadata associated with the command, a copy of the descriptor of the operation to be performed, so that the first signature also applies to the copy of the descriptor of the operation to be performed in order to make it possible, on reception, to verify that the command has not been altered during transmission; and
transmitting, to the smart meter in question, the command with the descriptor of the operation to be performed, the input attributes of the operation to be performed, the metadata associated with the command and the first signature generated.

11. A smart meter configured to process a command received from a management device in an automated management system where the management device is configured to remotely manage the smart meter, the command comprising a descriptor of an operation to be performed by the smart meter and input attributes of the operation to be performed and metadata associated with the command, wherein the smart meter comprises electronic circuitry configured to perform the following steps, on reception of the command, of verifying the command:
recovering, in the command received, the descriptor of the operation to be performed;
recovering, in the command received, the input attributes to be applied as an input of the operation to be performed, as well as the associated metadata;
verifying that the copy of the descriptor of the operation to be performed in the metadata recovered conforms to the descriptor of the operation to be performed recovered and, when such is not the case, rejecting the command;
recovering, in the command received, and verifying that the first signature in the command conforms to the input attributes to be applied as an input to the operation to be performed and to said metadata, including the copy of the descriptor of the operation to be performed, which were recovered in the command, and, when such is not the case, rejecting the command, and otherwise accepting the command.

12. A system for automated management of smart meters. further comprising a management device according to claim 10 and smart meters where each smart meter is configured to process a command received from the management device in an automated management system where the management device is configured to remotely manage the smart meter, the command comprising a descriptor of an operation to be performed by the smart meter and input attributes of the operation to be performed and metadata associated with the command, wherein the smart meter comprises electronic circuitry configured to perform the following steps, on reception of the command, of verifying the command:
recovering, in the command received, the descriptor of the operation to be performed;
recovering, in the command received, the input attributes to be applied as an input of the operation to be performed, as well as the associated metadata:
verifying that the copy of the descriptor of the operation to be performed in the metadata recovered conforms to the descriptor of the operation to be performed recovered and. when such is not the case, rejecting the command;
recovering, in the command received, and verifying that the first signature in the command conforms to the input attributes to be applied as an input to the operation to be performed and to said metadata, including the copy of the descriptor of the operation to be performed, which were recovered in the command, and, when such is not the case, rejecting the command. and otherwise accepting the command.

13. A method implemented by a smart meter in order to process a command received from a management device in an automated management system where the management device is configured to remotely manage the smart meter, the command comprising a descriptor of an operation to be performed by said smart meter and input attributes of the operation to be performed and metadata associated with the command, wherein the method comprises the following steps, on reception of the command, of verifying the command:
recovering, in the command received, the descriptor of the operation to be performed;
recovering, in the command received, the input attributes to be applied as an input of the operation to be performed, as well as the metadata associated with the command;
verifying that the copy of the descriptor of the operation to be performed in the metadata recovered conforms to the descriptor of the operation to be performed recovered and, when such is not the case, rejecting the command;
recovering, in the command received, and verifying that the first signature in the command conforms to the input attributes to be applied as an input to the operation to be performed and to said metadata, including the copy of the descriptor of the operation to be performed, which were recovered in the command, and, when such is not the case, rejecting the command, and otherwise accepting the command.

14. (canceled)

15. A non-transitory information-storage medium storing instructions causing an implementation, by a processor, of the method according to claim 1, when the instructions are read from the information-storage medium and executed by the processor.

16. A non-transitory information-storage medium storing instructions causing an implementation, by a processor, of the method according to claim 13, when the instructions are read from the information-storage medium and executed by the processor.
